(19) United States
(12) Patent Application Publication
(10) Pub. No.: US 2020/0343587 A1
(43) Pub. Date: Oct. 29, 2020

(54) CELL DESIGN OPTIMIZATION FOR NON-FLAMMABLE ELECTROLYTE

(71) Applicant: TeraWatt Technology Inc., Santa Clara, CA (US)

(72) Inventors: Chien-Po Huang, Campbell, CA (US); Yu-Hsin Huang, Milpitas, CA (US); Ying Liu, Santa Clara, CA (US); Yifan Tang, Santa Clara, CA (US); Chengyu Mao, Santa Clara, CA (US)

(73) Assignee: TeraWatt Technology Inc., Santa Clara, CA (US)

(21) Appl. No.: 16/392,649

(22) Filed: Apr. 24, 2019

(51) Int. Cl. H01M 10/0567; H01M 10/0568; H01M 10/0569; H01M 2/16; H01M 10/0525; H01M 4/58

(52) U.S. Cl. CPC H01M 10/0567; H01M 10/0568; H01M 10/0569; H01M 2300/0037; H01M 10/0525; H01M 4/5825; H01M 2/166

(57) ABSTRACT

A lithium ion rechargeable battery having an electrode and organic electrolyte, wherein the electrolyte includes a phosphor-based material that makes up between 1-20% by weight of the electrolyte. The phosphor-based material added to the electrolyte, in the concentration disclosed herein, does not alter or affect the electrochemical performance of the battery cell, including the capacity of the battery cell. The phosphor-based material is effective, at concentrations in the electrolyte of between 1-20% by weight, of curbing thermal runaway.

### BACKGROUND

Rechargeable lithium-ion batteries have become very popular in devices that utilize a rechargeable power source, such as for example cellular phones, electric vehicles, and other products. Lithium-ion batteries typically include electrodes wherein with a slurry applied to the surface of a current conductor. The current technology relates to a number of technical problems, including but not limited to safety issues. The organic electrolytes of a lithium-ion battery cell are mostly composed of highly flammable carbonate, which can experience thermal runaway or be ignited under extreme conditions such as physical abuse, overcharge or short circuiting.

Previous solutions at reducing the risk and damage associated with thermal runaway typically modify the battery cell structure or components to make the battery cell safer, but sacrifice significant battery performance. What is needed is a safer battery cell.

### SUMMARY

The present technology, roughly described, includes a lithium ion rechargeable battery having an electrode and organic electrolyte, wherein the electrolyte includes a phosphor-based material that makes up between 1-20% by weight of the electrolyte. The phosphor-based material added to the electrolyte, in the concentration disclosed herein, does not alter or affect the electrochemical performance of the battery cell, including the capacity of the battery cell. The phosphor-based material is effective, at concentrations in the electrolyte of between 1-20% by weight, of curbing thermal runaway. In some instances, TPP and/or TMPi include phosphor which bonds to free radicals generated by thermal runaway chain reactions to prevent heat build-up and reduce the chain reaction progress and heat generation.

In embodiments, a rechargeable battery cell having an electrolyte includes a cathode, anode, an electrolyte, and a container. The electrolyte includes a lithium material and phosphor-based material. The phosphor-based material makes up between 1-20% of the electrolyte by weight. The container encompasses the cathode, anode and electrolyte.

In embodiments, a method for manufacturing a rechargeable battery includes inserting at least one electrode into a rechargeable battery container. An electrolyte can be inserted into the rechargeable battery container as well. The electrolyte can include a phosphor-based material which makes up between 1-20% of the electrolyte by weight. The rechargeable battery container can then be sealed.

In embodiments, an electrolyte for a rechargeable battery cell includes an organic solvent, a lithium salt, and a phosphor-based material making up between 1-20% of the electrolyte by weight. The phosphor-based material can interact with hydrocarbons during thermal runaway of a rechargeable battery cell.

### BRIEF DESCRIPTION OF FIGURES

FIG. 1 is a schematic of an exemplary lithium ion battery under load.

FIG. 2 is a block diagram of an electrolyte having phosphor-based particles.

FIG. 3 is a structural formula for triphenyl phosphate.

FIG. 4 is a structural formula for trimethyl phosphite.

FIG. 5 is a Nyquist plot of impedance for charge transfer resistance.

FIG. 6 is a plot of a baseline electrolyte capacity vs. charge during battery cell discharge and charge.

FIG. 7 is a plot of a baseline and TPP electrolyte capacity vs. charge during battery cell discharge and charge.

FIG. 8 is a plot of a baseline and TMPi electrolyte capacity vs. charge during battery cell discharge and charge.

FIG. 9 is a method for manufacturing a rechargeable battery cell with an electrolyte having phosphor-based material.

FIG. 10 is a method of curbing thermal runaway in a battery cell.

### DETAILED DESCRIPTION

The present technology, roughly described, includes a lithium ion rechargeable battery having an electrode and organic electrolyte, wherein the electrolyte includes a phosphor-based material that makes up between 1-20% by weight of the electrolyte. The phosphor-based material added to the electrolyte, in the concentration disclosed herein, does not alter or affect the electrochemical performance of the battery cell, including the capacity of the battery cell. The phosphor-based material is effective, at concentrations in the electrolyte of between 1-20% by weight, of curbing thermal runaway. In some instances, TPP and/or TMPi include phosphor which bonds to free radicals generated by thermal runaway chain reactions to prevent heat build-up and reduce the chain reaction progress and heat generation.

The current technology relates to a number of technical problems, including but not limited to the challenges of manufacturing more lithium ion batteries that are safe. The organic electrolytes of a lithium-ion battery cell are mostly composed of highly flammable carbonate, which can experience thermal runaway or be ignited under extreme conditions such as physical abuse, overcharge or short circuiting. To solve such safety issues and reduce the damage and risk associated with thermal runaway, battery cells have been modified with elements such as redox shuttles, shut down feature separators, and the like. In some types of batteries, the addition of significant amounts, for example 25-35% by weight, of flame-retardant additives seem to be relatively economic and effective method to prevent thermal runaway. However, these flame-retardant additives (FRs) lower the cycling stability and cycle life of lithium ion battery cells. Previous battery cells with flame-retardant additives can reduce battery capacity as much as 10%.

The current technology provides a technical solution to the technical problem of lithium-ion battery safety, and specifically the risk and damage incurred from thermal runaway. Specifically, the present technology provides an improved lithium-ion battery having an electrolyte that includes a small amount by weight (e.g., less than 20% by weight) of a phosphor-based material that curbs thermal runaway while having minimal or no effect on battery cell capacity. As a result, a battery cell with an electrode made from the active material with an optimized concentration of phosphor-based material added into electrolyte provides a safer battery with no comprise to battery charge and discharge capacity performance.

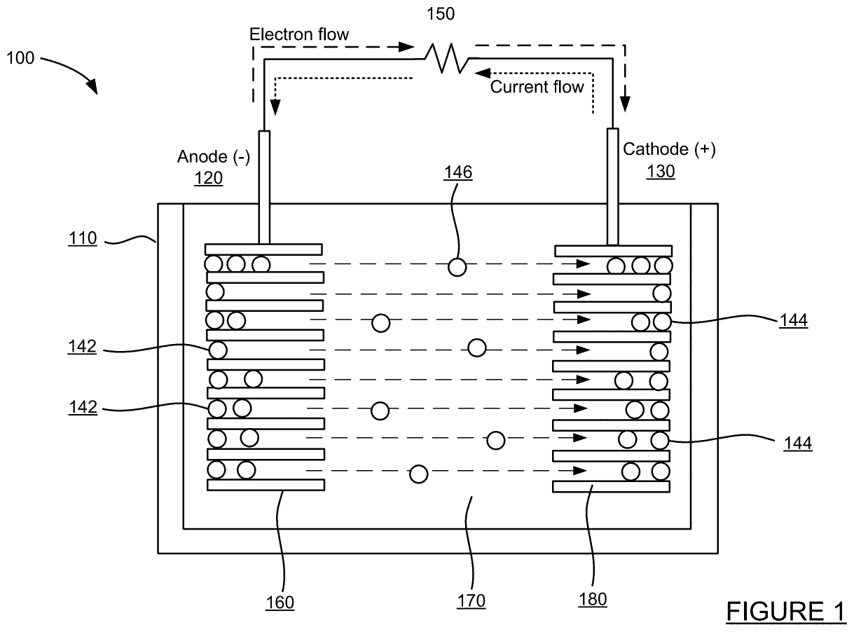

FIG. 1 is a schematic of an exemplary lithium ion battery under load. Battery cell 100 includes anode 120, cathode 130, lithium ions 142, 144, and 146, and electrolyte 170. The anode includes active material 160 and the cathode material includes active material 180. Electrolytes 170 are placed in a battery cell container 110 with the anode material 160 and cathode material 180. During discharge, the lithium ions 142 collected at the anode active material 160 move through the electrolyte 170 (see lithium ions 146) to position at and within the cathode active material 180 as lithium ions 144, resulting in a potential applied to load 150. During discharge, electrons travel from the anode to the cathode, causing current to travel from the cathode to the anode.

When the lithium battery is charged, a potential is applied between the anode and cathode. During charging, lithium ions 144 move from the positive cathode electrode 130 through the electrolyte (see lithium ions 146) and towards the negative anode electrode 120, where the lithium ions 142 are embedded into the anode active material 160 via intercalation. The electrons travel from the cathode to the anode, causing current to travel from the anode to the electrode.

As shown in FIG. 1, lithium-ion's embedded into an active material through intercalation exit the anode material, travel through an electrolyte, and are embedded in a cathode. The anode active material can be formed from carbon in the form of graphite particles.

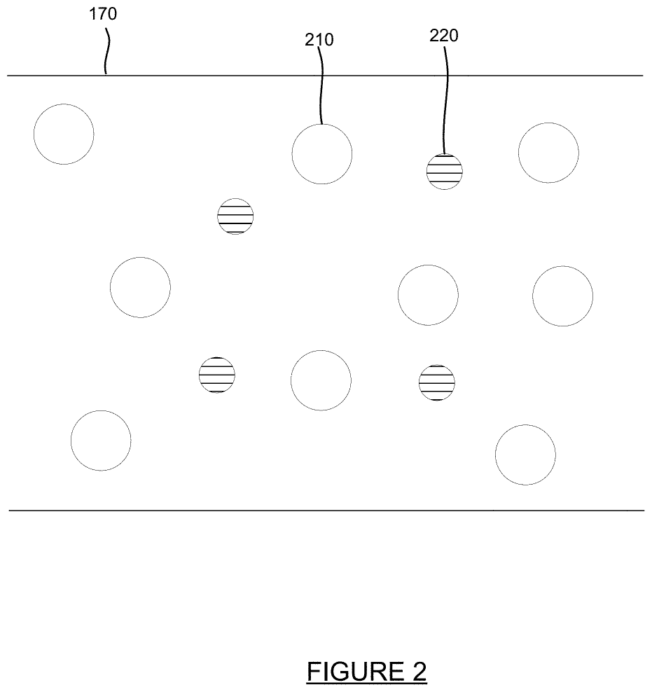

FIG. 2 is a block diagram of an electrolyte 200 having lithium salt and phosphor-based particles. Electrolyte 200 can include organic solvent, lithium salt and phosphor-based materials. The phosphor-based material can include the phosphor-based particles 220, and optionally other particles. The lithium salt particles 210 of FIG. 2 have a different shape and make up more of the electrolyte 200 by weight than the phosphor-based material 220. In some instances, the phosphor-based material 220 may make up between 1-20% of the electrolyte by weight. In some instances, the phosphor-based material may make up between 5-15% of the electrolyte by weight. In some instances, the phosphor-based material may make up less than 12% of the electrolyte by weight. The phosphor-based material within the electrolyte has a percentage make-up such that the phosphor-based material can effective curb a thermal runaway occurring in a battery cell while not significantly effecting the electromechanical properties of the battery cell.

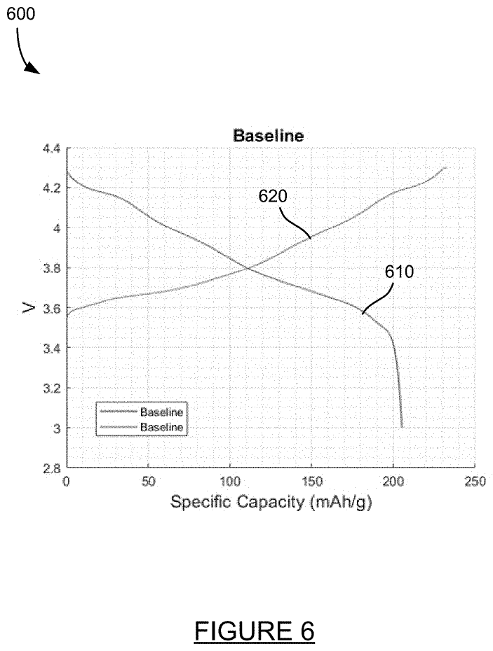

Electrolyte 200 can include organic solvent, lithium salt and phosphor-based materials illustrated in FIGS. 2 and 6 are not to scale, and are provided for exemplary discussion purposes. The scale of the particles, with respect to each other and other elements in the FIGURES discussed herein, is not intended to be exact and the present technology is not limited to the scale of any elements in the FIGURES.

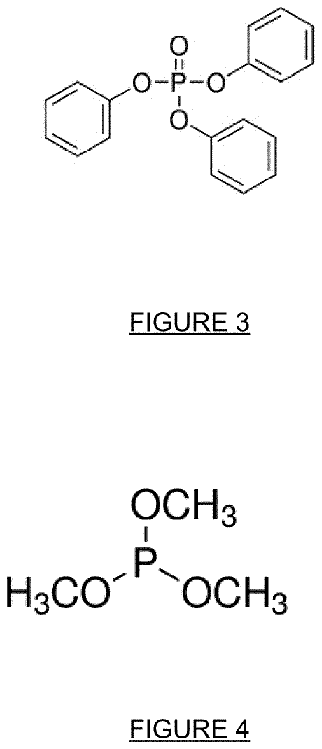

The phosphor-based materials can include compounds that include phosphate, phosphite, and other materials in the phosphor family. FIG. 3 is a structural formula for triphenyl phosphate. Triphenyl phosphate (TPP) can be used as a phosphor-based particle within an electrolyte of a battery cell. TPP has a linear molecular formula of (C₆H₅O)₃PO. FIG. 4 is a structural formula for trimethyl phosphite. Trimethyl phosphite (TMPi) can be used as a phosphor-based particle within an electrolyte of a battery cell as well, and has a linear molecular formula of (CH₃O)₃P. Both TTP and TMPi can be implemented in an electrolyte at or below 20% by weight, and can act to curb thermal runaway that can occur in a battery cell.

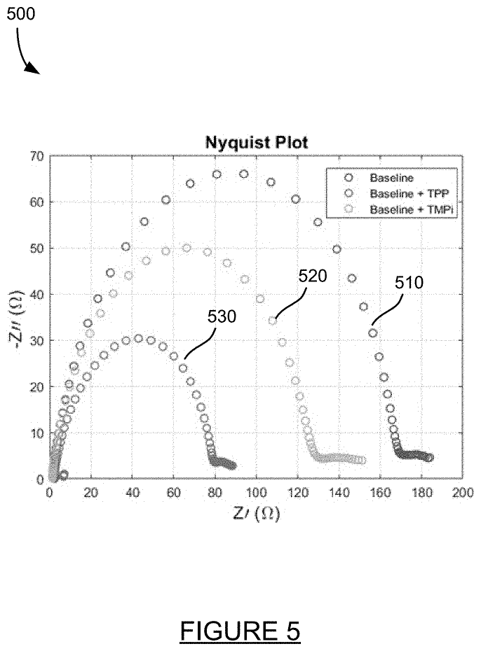

FIG. 5 is a Nyquist plot 500 of impedance for charge transfer resistance. In FIG. 5, an impedance for a charge transfer resistance of a base electrolyte is shown along with the impedance for a charge transfer resistance for electrolytes having phosphor-additives. EIS measurements were made on symmetric cells to determine the effects of the additives disclosed herein on the electrolyte. In particular, an impedance plot 520 for an electrolyte with TPP additive and an impedance plot 530 for an electrolyte with TMPi additive is shown. The Nyquist plot 500 depicts Z′ as an arc beginning at a combination electrolyte distance and an end representing charge transfer resistance. Z″ is depicted as a double layer capacitance. As shown in plot 500 of FIG. 5, the impedance for the baseline 510 reaches a maximum Z′ impedance of between 180 and 190 ohms and a maximum Z″ impedance of about 68 ohms. The impedance for the electrolyte with TPP 520 is less than the baseline impedance 510, with the impedance 520 reaching a maximum Z′ impedance of between 150 and 160 ohms and a maximum Z″ impedance of about 50 ohms. The impedance for the electrolyte with TMPi 530 is less than the TPP impedance 520, with the impedance 530 reaching a maximum Z′ impedance of between 90 and 100 ohms and a maximum Z″ impedance of about 30 ohms. As shown in the plot 500 of FIG. 5, the electrolytes with additives of TPP and TMPi both have lower impedance than an electrolyte without such additives, as shown by plot 510, and reduce the charge transfer resistance of the baseline electrolyte. The lower impedance indicates that the baseline electrolyte with TPP or TMPi has better power performance, and higher capacity retention, than the baseline electrolyte alone.

FIG. 6 is a plot of an electrolyte capacity vs. charge during battery cell discharge and charge. In FIG. 6, plot 620 illustrates charging characteristic and plot 610 illustrates a discharge characteristic. The specific capacity per voltage during charging (plot 620) shows an initial voltage of approximately 3.6 volts and rising to approximately 4.3 volts at 250 mAh/g capacity. The specific capacity per voltage during discharge (plot 610) shows an initial voltage of approximately 4.3 volts, dropping steadily to approximately 3.5 volts at about 200 mAh/g, and then falling to approximately 3 volts at about 205 mAh/g.

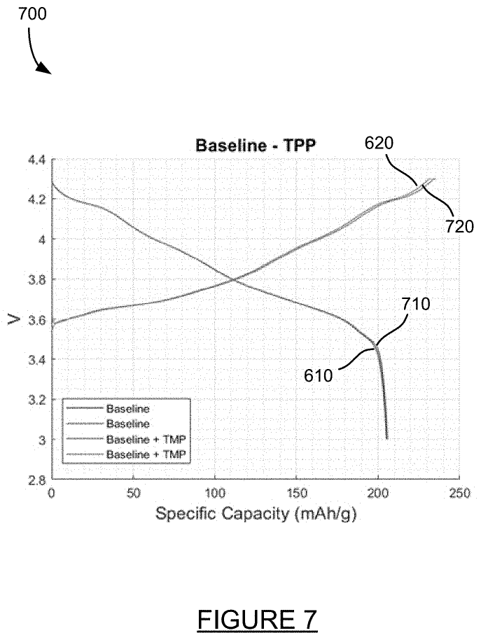

FIG. 7 is a plot of a baseline and TPP capacity vs. charge during battery cell discharge and charge. As shown in FIG. 7, the cell capacity during discharge of a battery with an electrolyte having TPP (plot 710) is about the same as discharge of a cell without TPP (plot 610). Similarly, the cell capacity during charging of a battery with an electrolyte having TPP (plot 720) is about the same as charging of a cell without TPP (plot 620). As such, having TPP within an electrolyte, at a concentration of between 1-20% by weight, does not materially affect the capacity of the cell. The plot shows a that an electrolyte with up to 20% by weight of TPP experiences a 1-2% difference in lithiation/delithiation capacity.

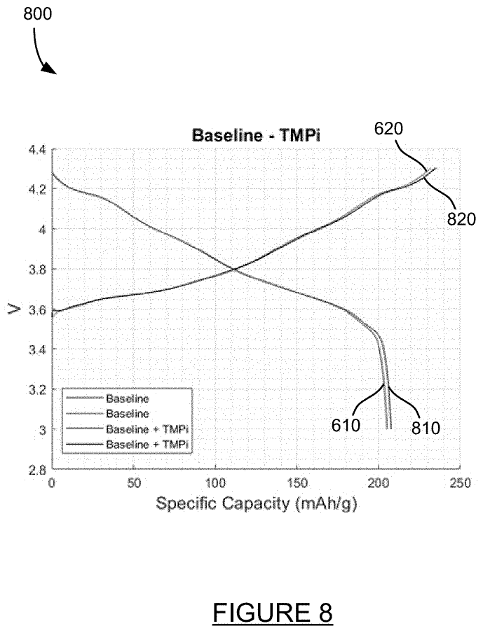

FIG. 8 is a plot of a baseline and TMPi capacity vs. charge during battery cell discharge and charge. As shown in FIG. 8, the cell capacity during discharge of a battery with an electrolyte having TMPi (plot 810) is about the same as discharge of a cell without TMP (plot 610). Similarly, the cell capacity during charging of a battery with an electrolyte having TMPi (plot 820) is about the same as charging of a cell without TMPi (plot 620). As such, having TMPi within an electrolyte, at a concentration of between 1-20% by weight, does not materially affect the capacity of the cell. The plot shows a that an electrolyte with up to 20% by weight of TMPi experiences a 1-2% difference in lithiation/delithiation capacity.

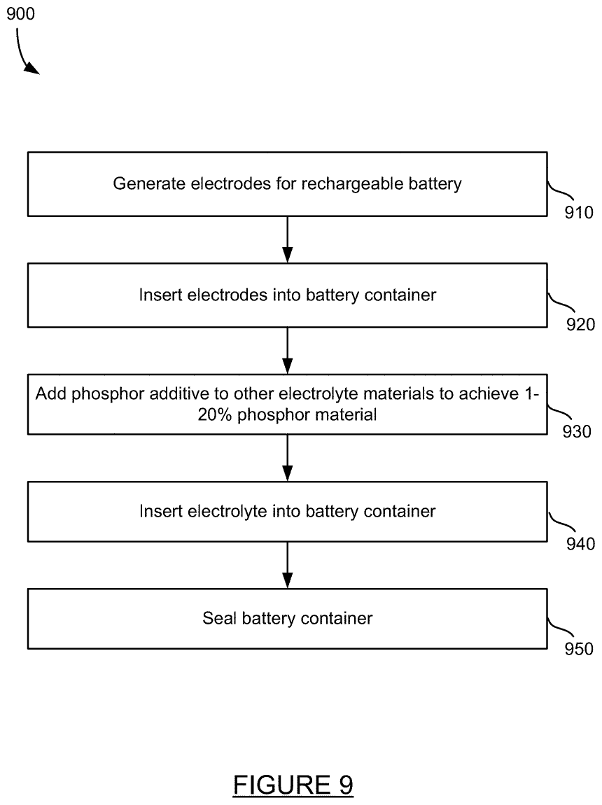

FIG. 9 is a method for manufacturing a rechargeable battery cell with an electrolyte having phosphor-based material. Electrodes are generated for the rechargeable battery at step 910. The electrodes may include an anode and a cathode, wherein the cathode includes a slurry applied to a thin aluminum foil or other current conductor and the anode includes a slurry of active material applied to a graphene sheet. The electrodes may be inserted into a rechargeable battery container at step 920.

An electrolyte is generated at step 930. To generate the electrolyte, a solvent is mixed with a lithium salt, and a phosphor-based material is added to the solvent-lithium salt mixture. The phosphor-based material is added such that the phosphor-based material makes up 1-20%, 5-15%, or 8-12% of the electrolyte. The electrolyte mixture as added to the battery container at step 940. The battery container is then sealed, with the electrodes and electrolyte inside the container, at step 950.

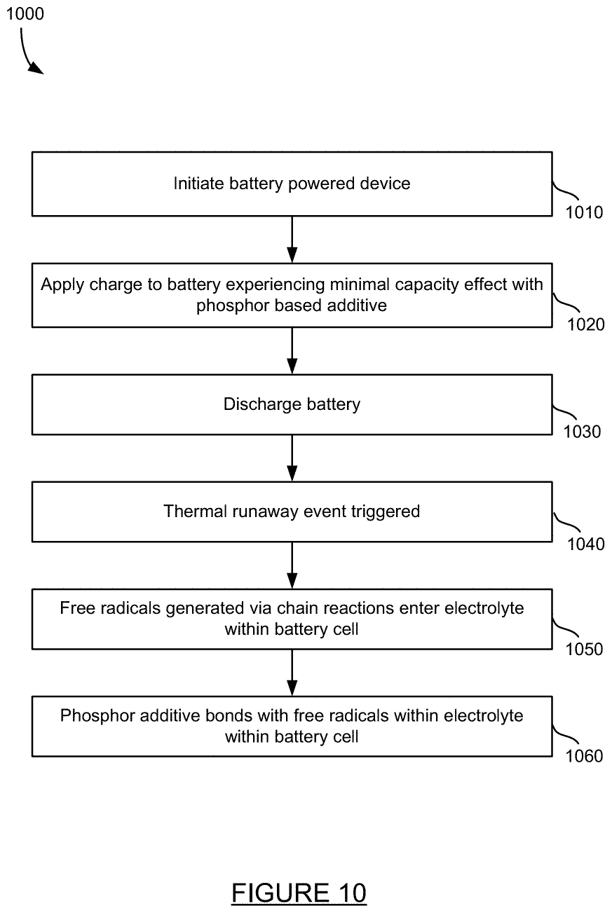

FIG. 10 is a method of curbing thermal runaway in a battery cell. A battery powered device can be initiated at step 1010. Initiating the device may include powering on the device. A charge may be applied to the battery in order to charge the battery at step 1020. The charge may be applied during a charging process of the battery cell. The battery cell may include electrolyte that includes a phosphor-based material which has minimal or no effect on battery cell capacity. The battery cell is discharged at step 1030. The discharge of the battery cell may experience little or no effect from the phosphor-based material included within the battery cell electrolyte.

At some point during the steps 1010-1030, a thermal runaway event is triggered at step 1040. The thermal runaway event may be any of several events that trigger a chain reaction of events which generate radicals and heat within a battery cell. In some instances, thermal runaway can be triggered during charging of the battery cell, but can occur based on other reasons as well. Organic compounds in an electrolyte can, during a chain reaction, produce radicals at step 1050. The radicals can include hydrocarbons and carbon contaminants. The radicals are very reactive and include unpaired electrons which cause heating of the cell and further reactions to generate additional heat.

The phosphor-based material in the electrolyte bonds with free radicals within the electrolyte within the battery cell at step 1060. In some instances, hydrogen and hydroxy radicals in the electrolyte are replaced by less effective radicals or are rendered harmless by radical recombination (bonding with phosphor based material) in the gas phase. Branching and chain reactions of the oxidation of hydrocarbons in the gas phase are slowed down or interrupted, which is called flame inhibition, and reduces the production of heat.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A rechargeable battery cell having an electrolyte, comprising:
a cathode;
an anode;
an electrolyte that includes a lithium material and phosphor-based material, the phosphor-based material making up between 1-20% of the electrolyte by weight; and
a container that encompasses the cathode, anode and electrolyte.

2. The rechargeable battery cell of claim 1, wherein the phosphor-based materials make up between 5-15% of the electrolyte by weight.

3. The rechargeable battery cell of claim 1, wherein the phosphor-based material includes triphenyl phosphate (TPP).

4. The rechargeable battery cell of claim 1, wherein the phosphor-based material includes trimethyl phosphite (TMPi)

5. The rechargeable battery cell of claim 1, wherein the electrolyte is generated by mixing organic solvent, lithium salt, and the phosphor-based material.

6. The rechargeable battery cell of claim 1, wherein the phosphor-based material interacts with hydrocarbons during thermal runaway of the rechargeable battery cell.

7. A method for manufacturing a rechargeable battery, comprising:
inserting at least one electrode into a rechargeable battery container;
inserting an electrolyte into the rechargeable battery container, the electrolyte including a phosphor-based material, the phosphor-based material making up between 1-20% of the electrolyte by weight; and
sealing the rechargeable battery container.

8. The method of claim 7, wherein the phosphor-based materials make up between 5-15% of the slurry by weight.

9. The method of claim 7, wherein the phosphor-based material includes triphenyl phosphate (TPP).

10. The method of claim 7, wherein the phosphor-based material includes trimethyl phosphite (TMPi)

11. The method of claim 7, wherein the electrolyte is generated by mixing organic solvent, lithium salt, and the phosphor-based material.

12. The method of claim 7, wherein the phosphor-based material interacts with hydrocarbons during thermal runaway of the rechargeable battery cell.

13. An electrolyte for a rechargeable battery cell, comprising:
an organic solvent;
lithium salt; and
phosphor-based material making up between 1-20% of the electrolyte by weight, the phosphor-based material interacting with hydrocarbons during thermal runaway of a rechargeable battery cell.

14. The electrolyte of claim 13, wherein the phosphor-based materials make up between 5-15% of the electrolyte by weight.

15. The electrolyte of claim 13, wherein the phosphor-based material includes triphenyl phosphate (TPP).

16. The electrolyte of claim 13, wherein the phosphor-based material includes trimethyl phosphite (TMPi).
